(19) United States
(12) Patent Application Publication
(10) Pub. No.: US 2024/0116484 A1
(43) Pub. Date: Apr. 11, 2024

(54) VEHICLE CONTROL DEVICE

(71) Applicant: HITACHI ASTEMO, LTD., Hitachinaka-shi, Ibaraki (JP)

(72) Inventors: Asahi WATANABE, Chiyoda-ku, Tokyo (JP); Toshiya OSAWA, Chiyoda-ku, Tokyo (JP); Masaru KONISHI, Chiyoda-ku, Tokyo (JP)

(73) Assignee: HITACHI ASTEMO, LTD., Hitachinaka-shi, Ibaraki (JP)

(21) Appl. No.: 18/553,616

(22) PCT Filed: Mar. 4, 2022
(86) PCT No.: PCT/JP2022/009298

§ 371 Date: Oct. 2, 2023

(30) Foreign Application Priority Data
Sep. 9, 2021 (JP) 2021-147219

(51) Int. Cl. B60T 8/94; B60T 8/88; B60T 13/14; B60T 13/62; B60T 13/68

(52) U.S. Cl. CPC B60T 8/94; B60T 8/885; B60T 13/142; B60T 13/148; B60T 13/62; B60T 13/686

(57) ABSTRACT

Provided is a brake control device which reliably generates wheel cylinder fluid pressure in all the wheels FR to RR even at the time of failure of the brake control device, can reliably decelerate or stop a vehicle, has a simplified system configuration, and has high reliability for automatic driving. A brake device 101 of the present invention includes a first fluid pressure unit 102p which supplies brake fluid to first wheel cylinders 118a and 118d, a second fluid pressure unit 102s which supplies brake fluid to second wheel cylinders 118b and 118c, and a connection pipe 119 which connects the first fluid pressure unit and the second fluid pressure unit to allow the brake fluid to flow. The first fluid pressure unit and the second fluid pressure unit open a first shut-off valve 104p and a second shut-off valve 104s, respectively, in a case where a failure is detected in at least one of the first fluid pressure unit and the second fluid pressure unit.

### TECHNICAL FIELD

The present invention relates to a brake control device compatible with automatic driving.

### BACKGROUND ART

Regarding the automatic driving, according to the automatic driving level and the responsibility sharing division defined in SAE J3016, the control responsibility is incurred on the system side at a so-called Level 3 or higher, and at Level 3, the final operation responsibility at the time of failure is on the driver, but the failure determination and the control transition are guaranteed at the system side. In addition, the entire state is guaranteed by the system at Level 4 or higher. Therefore, in a system component for automatic driving, high reliability is required, and redundancy that can maintain a function at the time of failure is required.

Also in the brake control device, redundancy for reliably decelerating and stopping the vehicle at the time of failure is essential, and PTL 1 discloses a brake control device including two fluid pressure control units (a first fluid pressure control unit, and a second fluid pressure control unit) as the redundancy configuration.

Here, the first fluid pressure control unit includes a first control unit (ECU), the second fluid pressure control unit includes a second control unit (ECU), and the shut-off valve that shuts off the communication between the master cylinder and the wheel cylinder connected to both units can be controlled by each of the two control units.

Therefore, for example, when the first control unit determines that a failure has occurred in the second fluid pressure control unit, the communication between the master cylinder and the wheel cylinder can be shut off by controlling the shut-off valve in the closing direction by the first control unit. The target wheel cylinder fluid pressure for the front wheels FR and FL can be realized by controlling an actuator of the first fluid pressure control unit as in the normal state, and the discharge fluid pressure for the pumps of the first fluid pressure control unit can be supplied not only to the wheel cylinders of the front wheels FR and FL but also to the wheel cylinders 102 of the rear wheels RL and RR through a fluid path (discharge fluid path 13A, connection fluid path 11A (11PA, 11SA), relay fluid path 11I (11IS, 11IP), connection fluid path 11B (11PB, 11SB), and the like) connecting the pumps and the wheel cylinders of the rear wheels RL and RR.

Therefore, the wheel cylinder fluid pressure can be generated for all the wheels FR to RR, and an appropriate fluid pressure (=braking force) can be secured.

### CITATION LIST

### Patent Literatures

PTL 1: JP 2018-149998 A

### SUMMARY OF INVENTION

### Technical Problem

In the above-described conventional brake control device, since the shut-off valve is installed on the first fluid pressure control unit (first control unit) side, for example, when the shut-off valve itself becomes inoperable due to a failure of the first control unit, even if the second fluid pressure control unit (second control unit) side is normal, the shut-off valve cannot be controlled in the closing direction, and the discharge fluid pressure of the pump in the second fluid pressure control unit escapes to the master cylinder reservoir tank. Therefore, the pump discharge fluid pressure cannot be supplied to the wheel cylinders of the front wheels FR and FL connected to the first fluid pressure control unit together with the wheel cylinders of the rear wheels RL and RR directly connected to the second fluid pressure control unit, which makes it difficult to secure an appropriate fluid pressure.

In addition, in order to control a valve installed in one of the fluid pressure control units (control units) from another control unit, a control unit configuration or a harness connecting both the control units are newly required, which causes a problem of complicating a system configuration.

An object of the present invention is to provide a brake control device that reliably generates wheel cylinder fluid pressure for all the wheels FR to RR even at the time of such failure, can reliably decelerate or stop a vehicle, has a simplified system configuration, and has high reliability for automatic driving.

### Solution to Problem

In order to solve the above problem, a brake control device of the present invention is a brake device mounted on a vehicle, the brake device including: a first fluid pressure unit which supplies brake fluid to at least one first wheel cylinder; a second fluid pressure unit which supplies brake fluid to at least one second wheel cylinder; and a connection pipe which connects the first fluid pressure unit and the second fluid pressure unit and allows the brake fluid to flow, wherein the first fluid pressure unit includes a first shut-off valve which blocks a flow of the brake fluid relative to the connection pipe, and a first control unit which controls opening and closing of the first shut-off valve, and the second fluid pressure unit includes a second shut-off valve which blocks a flow of the brake fluid relative to the connection pipe, and a second control unit which controls opening and closing of the second shut-off valve, and the first control unit and the second control unit respectively open the first shut-off valve and the second shut-off valve in a case where a failure of at least one of the first fluid pressure unit and the second fluid pressure unit is detected.

### Advantageous Effects of Invention

According to the present invention, since the two fluid pressure units and the control unit included in each unit are separated, even if a failure occurs in one of the fluid pressure units, the other fluid pressure unit is not affected by the failure. Therefore, the discharge fluid pressure from the other fluid pressure unit can be supplied to the first wheel cylinder and the second wheel cylinder, and the braking force can be secured, so that higher reliability can be obtained.

### BRIEF DESCRIPTION OF DRAWINGS

FIG. 1 is a diagram illustrating a configuration of a fluid pressure control system 101 according to a first embodiment.

FIG. 2 is a diagram illustrating a configuration of a fluid pressure control system 201 according to a second embodiment.

FIG. 3 is a diagram illustrating a configuration of a fluid pressure control system 301 according to a third embodiment.

FIG. 4 is a flowchart illustrating a flow of brake control processing in a control unit in the first, second, and third embodiments.

FIG. 5 is a diagram illustrating a configuration of a fluid pressure control system 401 according to a fourth embodiment.

FIG. 6 is a diagram illustrating a configuration of a fluid pressure control system 501 according to a fifth embodiment.

FIG. 7 is a flowchart illustrating a flow of brake control processing in a control unit in the fourth and fifth embodiments.

### DESCRIPTION OF EMBODIMENTS

### First Embodiment

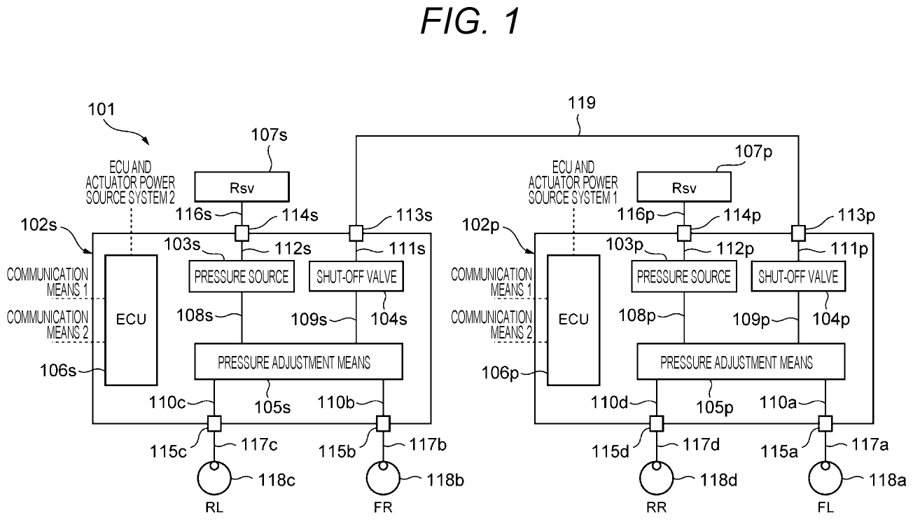

FIG. 1 is a configuration diagram of a fluid pressure control system 101 according to a first embodiment.

The fluid pressure control system 101 is a system mainly assumed to be applied to an automatic driving vehicle of Level 4 or higher, and constitutes a brake device mounted on the vehicle. In each unit of FIG. 1, a sign “p” at the end of the reference sign indicates that the unit corresponds to the primary system (P system) of a wheel cylinder 118. A sign “s” at the end of the reference sign indicates that the unit corresponds to the secondary system (S system) of the wheel cylinder 118. Hereinafter, when the P system and S system are not distinguished, the sign of p and s are omitted. A sign “a” at the end of the reference sign indicates that the unit corresponds to the left front wheel FL. Similarly, a sign “b” at the end of the reference sign indicates that the unit corresponds the right front wheel FR, a sign “c” at the end of the reference sign indicates that the unit corresponds the left rear wheel RL, and a sign “d” at the end of the reference sign indicates that the unit corresponds the right rear wheel RR. When the wheels FL to RR are not distinguished, the signs a, b, c, and d are omitted. Furthermore, a sign “f” at the end of the reference sign indicates that the unit corresponds the front wheels FL/FR, and a sign “r” at the end of the reference sign indicates that the unit corresponds the rear wheels RL/RR. When the front wheel and the rear wheel are not distinguished, the signs of f and r are omitted.

The fluid pressure control system 101 generates a brake fluid pressure (wheel cylinder fluid pressure) in the wheel cylinder (braking force applying unit) 118 to press a brake pad provided on each of the wheels FL to RR against a brake disc provided on the wheel side to apply a braking force to each of the wheels FL to RR.

The fluid pressure control system 101 includes a first unit 102p and a second unit 102s. The first unit 102p and the second unit 102s are units in which a pressure source 103, a shut-off valve 104, a pressure adjustment means 105, and an ECU 106 are integrally provided.

The first unit 102p and the second unit 102s have a unit connection port 113, a suction port 114, and a wheel cylinder port 115. The unit connection port 113 is connected to a unit connection pipe 119 and is connected to the shut-off valve 104 via a connection fluid path 111. The first unit 102p and the second unit 102s are connected via the unit connection pipe 119.

The suction port 114 is connected to a suction hose 116 and is connected to the pressure source 103 via the connection fluid path 112. The first unit 102p and the second unit 102s are connected to a reservoir tank 107 via the suction hose 116. The reservoir tank 107 is a brake fluid source which stores brake fluid, and is a low pressure portion in which the atmospheric pressure is released.

The wheel cylinder port 115 is connected to a wheel cylinder pipe 117 and is connected to the pressure adjustment means 105 via a connection fluid path 110. The first unit 102p and the second unit 102s are connected to the wheel cylinder 118 via the wheel cylinder pipe 117. A so-called X (cross) piping configuration where the primary system of the first unit 102p is connected to a left front wheel cylinder 118a and a right rear wheel cylinder 118d, while the secondary system of the second unit 102s is connected to a right front wheel cylinder 118b and a left rear wheel cylinder 118c, is adopted. An H pipe connecting the front wheel to the primary system and the rear wheel to the secondary system may be used.

The pressure source 103 and the pressure adjustment means 105 are connected via a connection fluid path 108. In addition, the shut-off valve 104 and the pressure adjustment means 105 are connected via a connection fluid path 109.

The pressure source 103 sucks the brake fluid stored in the reservoir tank 107 and discharges fluid of a required flow rate to the pressure adjustment means 105, based on a command from the ECU 106.

The pressure adjustment means 105 adjusts the pressure of the brake fluid supplied from the pressure source 103 based on a command from the ECU 106, and outputs a desired pressure to the wheel cylinder 118 and the shut-off valve 104 side. Here, in the pressure adjustment means 105, the connection fluid path 109 and the connection fluid path 110 communicate with each other (not illustrated).

The shut-off valve 104 opens or closes based on a command from the ECU 106 to communicate or block between the connection fluid path 109 and the connection fluid path 111. Note that the shut-off valve 104 has a so-called normally open structure, and the shut-off valve 104 is opened, that is, the connection fluid path 109 and the connection fluid path 111 are in an open state, or a communicating state when there is no command (electric signal) from the ECU 106 or no electricity is supplied.

The ECU 106 is an electronic control unit (ECU) that controls the first unit 102p and the second unit 102s, receives a signal (target brake fluid pressure) from another ECU, and controls the pressure source 103, the shut-off valve 104, and the pressure adjustment means 105 as described above.

The wheel cylinders 118a and 118d of the present embodiment correspond to a first wheel cylinder in the claims, the wheel cylinders 118b and 118c of the present embodiment correspond to a second wheel cylinder in the claims, the first unit 102p and the second unit 102s of the present embodiment correspond to a first fluid pressure unit and a second fluid pressure unit in the claims, and the unit connection pipe 119 of the present embodiment corresponds to a connection pipe in the claims. Shut-off valves 104p and 104s of the present embodiment correspond to a first shut-off valve and a second shut-off valve in the claims, and ECUs 106p and 106s of the present embodiment correspond to a first control unit and a second control unit in the claims. Pressure sources 103p and 103s of the present embodiment correspond to a first pressure feeding unit and a second pressure feeding unit in the claims, and pressure adjustment means 105p and 105s of the present embodiment correspond to a first pressure adjustment unit and a second pressure adjustment unit in the claims.

Next, an operation of the fluid pressure control system 101 according to the first embodiment will be described.

(Normal Control in System Normal State)

In the first unit 102p and the second unit 102s, the shut-off valve 104 is closed by a command from the ECU 106, and the connection fluid path 109 and the connection fluid path 111 are blocked. In addition, the pressure source 103 and the pressure adjustment means 105 are controlled, a desired pressure is output to the wheel cylinder 118, and a required braking force is applied to each of the wheels FL to RR of the wheel cylinder 118.

(Backup Control at the Time of System Failure)

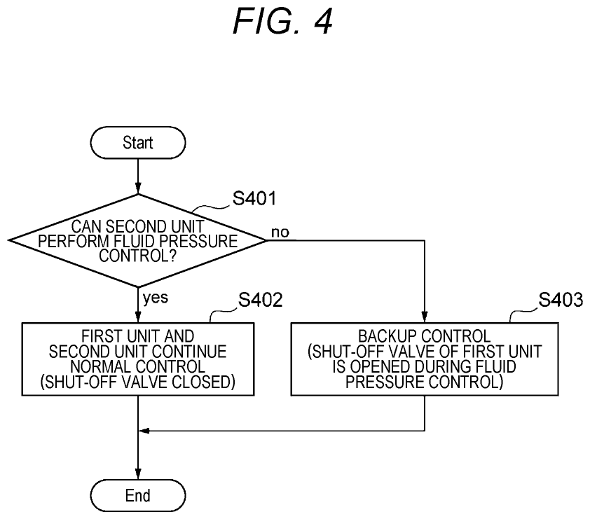

Here, as an example, processing performed by the ECU 106 when the second unit 102s fails (failure) will be described with reference to the flowchart of FIG. 4.

In step S401, it is determined whether the second unit 102s can perform fluid pressure control. The determination is made by a failure detection logic (not illustrated) of the pressure source 103, the shut-off valve 104, the pressure adjustment means 105, and the ECU 106 incorporated in the ECU 106. When it is determined that the fluid pressure control is possible, the process proceeds to step S402. When it is determined that the fluid pressure control is impossible, or the system fails, the process proceeds to step S403.

In step S402, the normal control in the system normal state described in the paragraph [0025] is continued.

In step S403, the process proceeds to backup control. That is, the shut-off valve 104p of the first unit 102p is opened. With this operation, a connection fluid path 109p and a connection fluid path 111p communicate with each other, and the pressure adjusted by the pressure adjustment means 105p is applied to a unit connection port 113s of the second unit 102s via the unit connection pipe 119 together with the wheel cylinders 118a/118d.

In the second unit 102s, when it is determined that the system fails, the pressure source 103s, the shut-off valve 104s, and the pressure adjustment means 105s are deactivated (non-electrified), the shut-off valve 104s is opened, and a connection fluid path 109s and a connection fluid path 111s communicate with each other. That is, the ECUs 106p and 106s open the shut-off valves 104p and 104s, respectively, when a failure is detected in one of the first unit 102p and the second unit 102s.

Therefore, the pressure adjusted by the pressure adjustment means 105p of the first unit 102p is also applied to wheel cylinders 118b/118c from a unit connection port 113s of the second unit 102s via the connection fluid path 111s, the connection fluid path 109s, the pressure adjustment means 105s, connection fluid paths 110b/110c, wheel cylinder ports 115b/115c, and wheel cylinder pipes 117b/117c.

As a result, even when the second unit 102s fails, a desired pressure is output to the wheel cylinder 118 similarly to the system normal state, and a necessary braking force can be applied to each of the wheels FL to RR of the wheel cylinder 118.

Note that the above is an example of a case where the second unit 102s fails, but even in a case where the first unit 102p fails, the first unit 102p and the second unit 102s are only replaced in the processing of step S403, and the operation itself is similar.

Next, operational effects of the first embodiment will be described.

The fluid pressure control system 101 according to the first embodiment includes two units having the same configuration, the first unit 102p and the second unit 102s. The first unit 102p includes the ECU 106p, and the second unit 102s includes the ECU 106s. In each unit, the shut-off valve 104 controlled only by the ECU 106 included in each unit is provided, and the upstream side (the side opposite to the wheel cylinder) of the shut-off valve 104 provided in each unit is connected by the unit connection pipe 119.

Therefore, since the two units and the ECUs included in each unit are separated, even if a failure occurs in one of the units or one of the ECUs, the other unit or ECU is not affected by the failure. Therefore, the discharge fluid pressure from the other unit can be supplied to all the wheels, and the braking force can be secured, so that higher reliability can be obtained.

In addition, since the two units have the same configuration and do not have a configuration in which the shut-off valve is controlled by the two ECUs as shown in the prior art, there is also an advantage that the system configuration is simplified.

### Second Embodiment

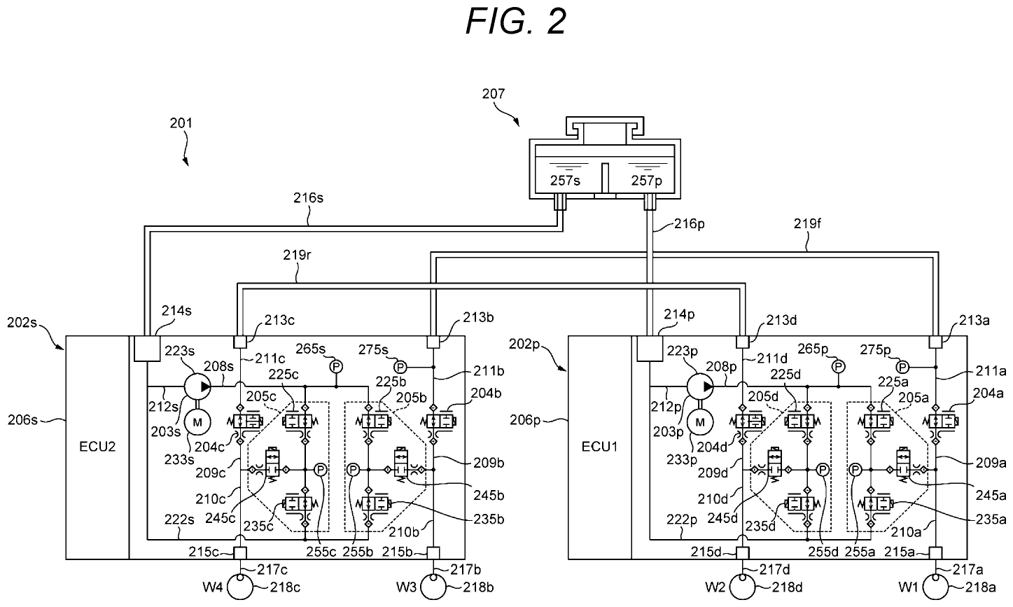

FIG. 2 is a configuration diagram of a fluid pressure control system 201 according to a second embodiment, and the system is a system mainly assumed to be applied to automatic driving vehicles of Level 4 or higher as in the first embodiment.

The fluid pressure control system 201 generates a brake fluid pressure (wheel cylinder fluid pressure) in the wheel cylinder (braking force applying unit) 218 to press a brake pad provided on each of the wheels FL to RR against a brake disc provided on the wheel side to apply a braking force to each of the wheels FL to RR.

The fluid pressure control system 201 includes a first unit 202p and a second unit 202s. Each of the first unit 202p and the second unit 202s is a unit in which a pressure source 203, a shut-off valve 204, a pressure adjustment means 205, and an ECU 206 are integrally provided.

The first unit 202p and the second unit 202s have a unit connection port 213, a suction port 214, and a wheel cylinder port 215.

The unit connection port 213 is connected to a unit connection pipe 219 and is connected to the shut-off valve 204 via a connection fluid path 211. The first unit 202p and the second unit 202s are connected via the unit connection pipe 219.

The suction port 214 is connected to a suction hose 216 and is connected to the pressure source 203 via the connection fluid path 212. The first unit 202p and the second unit 202s are connected to a reservoir tank 207 via the suction hose 216. Specifically, the reservoir tank 207 is partitioned into two sections, a primary fluid chamber 257p is connected to the first unit 202p, and a secondary fluid chamber 257s is connected to the second unit 202s. The reservoir tank 207 is a brake fluid source that stores brake fluid, and is a low pressure portion in which the atmospheric pressure is released.

The wheel cylinder port 215 is connected to a wheel cylinder pipe 217 and is connected to the pressure adjustment means 205 via a connection fluid path 210. The first unit 202p and the second unit 202s are connected to the wheel cylinder 218 via the wheel cylinder pipe 217. A so-called X (cross) piping configuration where the primary system of the first unit 202p is connected to a left front wheel cylinder 218a and a right rear wheel cylinder 218d, while the secondary system of the second unit 202s is connected to a right front wheel cylinder 218b and a left rear wheel cylinder 218c, is adopted. An H pipe connecting the front wheel to the primary system and the rear wheel to the secondary system may be used.

The pressure source 203 and the pressure adjustment means 205 are connected via a connection fluid path 208. In addition, the shut-off valve 204 and the pressure adjustment means 205 are connected via a connection fluid path 209.

The pressure source 203 includes a pump 223 and a motor 233 that drives the pump. Based on a command from the ECU 206, the motor 233 is rotationally controlled to suck the brake fluid stored in the reservoir tank 207 and discharge fluid of a required flow rate to the pressure adjustment means 205.

The pressure adjustment means 205 includes a pressure increasing control valve 225, a pressure reducing control valve 235, a communication valve 245, a pressure sensor 255, and a pressure sensor 265, and adjusts the pressure of the brake fluid supplied from the pressure source 203 based on a command from the ECU 206. That is, the pressure detected by the pressure sensors 255/265 is fed back. When the pressure is increased, the pressure increasing control valve 225 is opened, and the pressure reducing control valve 235 is closed. When the pressure is reduced, the pressure increasing control valve 225 is closed, and the pressure reducing control valve 235 is opened. As a result, a desired pressure is obtained. The adjusted pressure is output to the wheel cylinder 218 and the shut-off valve 204 side by opening the communication valve 245.

The shut-off valve 204 opens or closes based on a command from the ECU 206 to communicate or block between the connection fluid path 209 and the connection fluid path 211. Note that the shut-off valve 204 has a so-called normally open structure, and the shut-off valve 204 is opened, that is, the connection fluid path 209 and the connection fluid path 211 are in an open state, or a communicating state when there is no command (electric signal) from the ECU 206 or no electricity is supplied.

The ECU 206 is an electronic control unit (ECU) that controls the first unit 202p and the second unit 202s, receives a signal (target brake fluid pressure) from another ECU, and controls the pressure source 203, the shut-off valve 204, and the pressure adjustment means 205 as described above.

Next, an operation of the fluid pressure control system 201 according to the second embodiment will be described.

(Normal Control in System Normal State)

In the first unit 202p and the second unit 202s, the shut-off valve 204 is closed by a command from the ECU 206, and the connection fluid path 209 and the connection fluid path 211 are blocked. In addition, the pressure source 203 and the pressure adjustment means 205 are controlled, a desired pressure is output to the wheel cylinder 218, and a required braking force is applied to each of the wheels FL to RR of the wheel cylinder 218.

(Backup Control at the Time of System Failure)

Here, as an example, processing performed by the ECU 206 when the second unit 202s fails will be described with reference to the flowchart of FIG. 4.

In step S401, it is determined whether the second unit 202s can perform fluid pressure control. The determination is made by a failure detection logic (not illustrated) of the pressure source 203, the shut-off valve 204, the pressure adjustment means 205, and the ECU 206 incorporated in the ECU 206. When it is determined that the fluid pressure control is possible, the process proceeds to step S402. When it is determined that the fluid pressure control is impossible, or the system fails, the process proceeds to step S403.

In step S402, the normal control in the system normal state described in the paragraph [0050] is continued.

In step S403, the process proceeds to backup control. That is, a shut-off valves 204a/204d of the first unit 202p is opened. With this operation, a connection fluid path 209a and a connection fluid path 211a, and a connection fluid path 209d and a connection fluid path 211d communicate with each other, and the pressure adjusted by the pressure adjustment means 205a/205d is applied to unit connection ports 213b/213c of the second unit 202s via the unit connection pipe 219 together with the wheel cylinders 218a/218d.

In the second unit 202s, when it is determined that the system fails, the pressure source 203s, the shut-off valves 204b/204c, and the pressure adjustment means 205b/205c are deactivated (non-electrified), the shut-off valves 204b/204c is opened, and a connection fluid path 209b and a connection fluid path 211b, and a connection fluid path 209c and a connection fluid path 211c communicate with each other.

Therefore, the pressure adjusted by the pressure adjustment means 205a/205d of the first unit 202p is also applied to wheel cylinders 218b/218c from unit connection ports 213b/213c of the second unit 202s via connection fluid paths 211b/211c, connection fluid paths 209b/209c, connection fluid paths 210b/210c, wheel cylinder ports 215b/215c, and wheel cylinder pipes 217b/217c.

As a result, even when the second unit 202s fails, a desired pressure is output to the wheel cylinder 218 similarly to the system normal state, and a necessary braking force can be applied to each of the wheels FL to RR of the wheel cylinder 218.

Note that the above is an example of a case where the second unit 202s fails, but even in a case where the first unit 202p fails, the first unit 202p and the second unit 202s are only replaced in the processing of step S403, and the operation itself is similar.

Next, operational effects of the second embodiment will be described.

The fluid pressure control system 201 according to the second embodiment includes two units having the same configuration, the first unit 202p and the second unit 202s. The first unit 202p includes the ECU 206p, and the second unit 202s includes the ECU 206s. In each unit, the shut-off valve 204 controlled only by the ECU 206 included in each unit is provided, and the upstream side (the side opposite to the wheel cylinder) of the shut-off valve 204 provided in each unit is connected by the unit connection pipe 219.

Therefore, since the two units and the ECUs included in each unit are separated, even if a failure occurs in one of the units or one of the ECUs, the other unit or ECU is not affected by the failure. Therefore, the discharge fluid pressure from the other unit can be supplied to all the wheels, and the braking force can be secured, so that higher reliability can be obtained.

In addition, since the two units have the same configuration and do not have a configuration in which the shut-off valve is controlled by the two ECUs as shown in the prior art, there is also an advantage that the system configuration is simplified.

### Third Embodiment

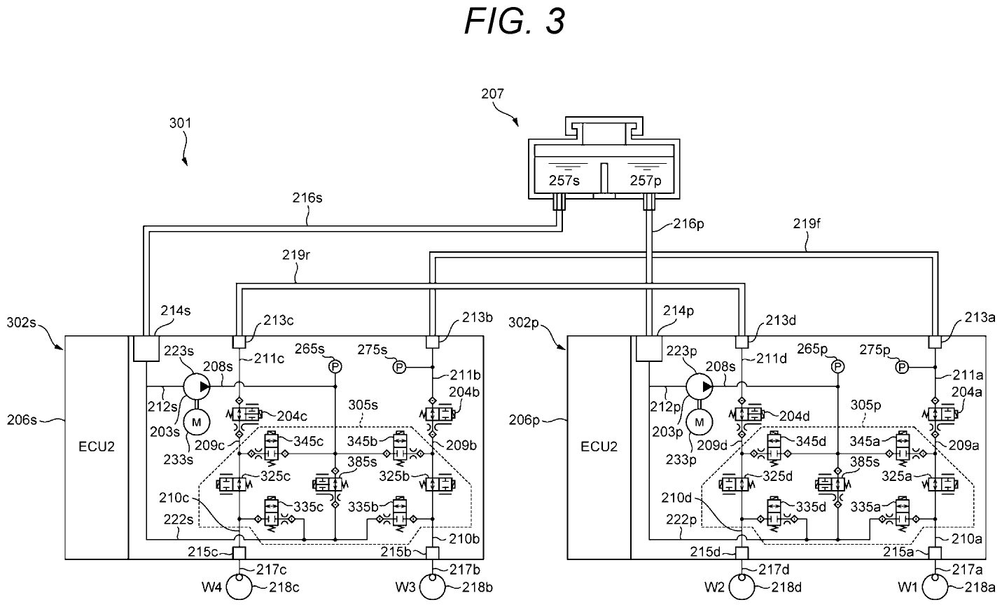

FIG. 3 is a configuration diagram of a fluid pressure control system 301 according to a third embodiment, and the system is a system mainly assumed to be applied to automatic driving vehicles of Level 4 or higher as in the first embodiment.

Since the basic configuration of the third embodiment is the same as that of the second embodiment, only the difference from the second embodiment will be described.

The fluid pressure control system 301 includes a first unit 302p and a second unit 302s. Each of the first unit 302p and the second unit 302s is a unit in which a pressure source 203, a shut-off valve 204, a pressure adjustment means 305, and an ECU 206 are integrally provided. Here, since the third embodiment is the same as the second embodiment except for the pressure adjustment means 305, parts related to the pressure adjustment means 305 will be described below.

The pressure adjustment means 305 includes a pressure increasing control valve 325, a pressure reducing control valve 335, a communication valve 345, a pressure adjustment valve 385, and a pressure sensor 265, and adjusts the pressure of the brake fluid supplied from the pressure source 203 based on a command from the ECU 206. That is, the pressure detected by the pressure sensor 265 is fed back. First, a first desired pressure is obtained by the pressure adjustment valve 385, sent to the shut-off valve 204 side and the pressure increasing control valve 325 side via the communication valve 345. Further, a second desired pressure is obtained by the pressure increasing control valve 325 and the pressure reducing control valve 335, and output to the wheel cylinder 218.

Note that the pressure increasing control valve 325 and the pressure reducing control valve 335 in the pressure adjustment means 305 operate only at the time of vehicle behavior control such as so-called ABS or ESC, and do not operate in a normal brake in which the vehicle behavior control does not intervene. Note that the pressure increasing control valve 325 has a so-called normally open structure, and the pressure increasing control valve 325 is opened, that is, the connection fluid path 209 and the connection fluid path 210 are in an open state, or a communicating state when there is no command (electric signal) from the ECU 206 or no electricity is supplied. Note that the pressure reducing control valve 335 has a so-called normally close structure, and the pressure reducing control valve 335 is closed, that is, the connection fluid path 210 and the connection fluid path 222 are in a close state, or a blocking state when there is no command (electric signal) from the ECU 206 or no electricity is supplied.

Therefore, in the case of a normal brake, the first desired pressure is directly output to the wheel cylinder 218.

The ECU 206 is an electronic control unit (ECU) that controls the first unit 302p and the second unit 302s, receives a signal (target brake fluid pressure) from another ECU, and controls the pressure source 203, the shut-off valve 204, and the pressure adjustment means 305 as described above.

Next, the operation of the fluid pressure control system 301 of the third embodiment will be described.

(Normal Control in System Normal State)

In the first unit 302p and the second unit 302s, the shut-off valve 204 is closed by a command from the ECU 206, and the connection fluid path 209 and the connection fluid path 211 are blocked. In addition, the pressure source 203 and the pressure adjustment means 305 are controlled, a desired pressure is output to the wheel cylinder 218, and a required braking force is applied to each of the wheels FL to RR of the wheel cylinder 218.

(Backup Control at the Time of System Failure)

Here, as an example, processing performed by the ECU 206 when the second unit 302s fails will be described with reference to the flowchart of FIG. 4.

In step S401, it is determined whether the second unit 302s can perform fluid pressure control. The determination is made by a failure detection logic (not illustrated) of the pressure source 203, the shut-off valve 204, the pressure adjustment means 305, and the ECU 206 incorporated in the ECU 206. When it is determined that the fluid pressure control is possible, the process proceeds to step S402. When it is determined that the fluid pressure control is impossible, or the system fails, the process proceeds to step S403.

In step S402, the normal control in the system normal state described in the paragraph [0069] is continued.

In step S403, the process proceeds to backup control. That is, a shut-off valves 204a/204d of the first unit 302p is opened. With this operation, a connection fluid path 209a and the connection fluid path 211a, and the connection fluid path 209d and the connection fluid path 211d communicate with each other, and the pressure (first desired pressure) adjusted by pressure adjustment means 305p is applied to the unit connection ports 213b/213c of the second unit 302s via the unit connection pipe 219 together with the wheel cylinders 218a/218d.

In the second unit 302s, when it is determined that the system fails, the pressure source 203s, the shut-off valves 204b/204c, and the pressure adjustment means 305s are deactivated (non-electrified), the shut-off valves 204b/204c is opened, and a connection fluid path 209b and a connection fluid path 211b, and a connection fluid path 209c and a connection fluid path 211c communicate with each other. In addition, the connection fluid path 209b and the connection fluid path 210b, and the connection fluid path 209c and the connection fluid path 210c communicate with each other.

Therefore, the pressure adjusted by the pressure adjustment means 305p of the first unit 302p is also applied to wheel cylinders 218b/218c from unit connection ports 213b/213c of the second unit 302s via connection fluid paths 211b/211c, connection fluid paths 209b/209c, connection fluid paths 210b/210c, wheel cylinder ports 215b/215c, and wheel cylinder pipes 217b/217c.

As a result, even when the second unit 302s fails, a desired pressure is output to the wheel cylinder 218 similarly to the system normal state, and a necessary braking force can be applied to each of the wheels FL to RR of the wheel cylinder 218.

Note that the above is an example of a case where the second unit 302s fails, but even in a case where the first unit 302p fails, the first unit 302p and the second unit 302s are only replaced in the processing of step S403, and the operation itself is similar.

Next, operational effects of the third embodiment will be described.

The fluid pressure control system 301 according to the third embodiment includes two units having the same configuration, the first unit 302p and the second unit 302s. The first unit 302p includes the ECU 206p, and the second unit 302s includes the ECU 206s. In each unit, the shut-off valve 204 controlled only by the ECU 206 included in each unit is provided, and the upstream side (the side opposite to the wheel cylinder) of the shut-off valve 204 provided in each unit is connected by the unit connection pipe 219.

Therefore, since the two units and the ECUs included in each unit are separated, even if a failure occurs in one of the units or one of the ECUs, the other unit or ECU is not affected by the failure. Therefore, the discharge fluid pressure from the other unit can be supplied to all the wheels, and the braking force can be secured, so that higher reliability can be obtained.

In addition, since the two units have the same configuration and do not have a configuration in which the shut-off valve is controlled by the two ECUs as shown in the prior art, there is also an advantage that the system configuration is simplified.

### Fourth Embodiment

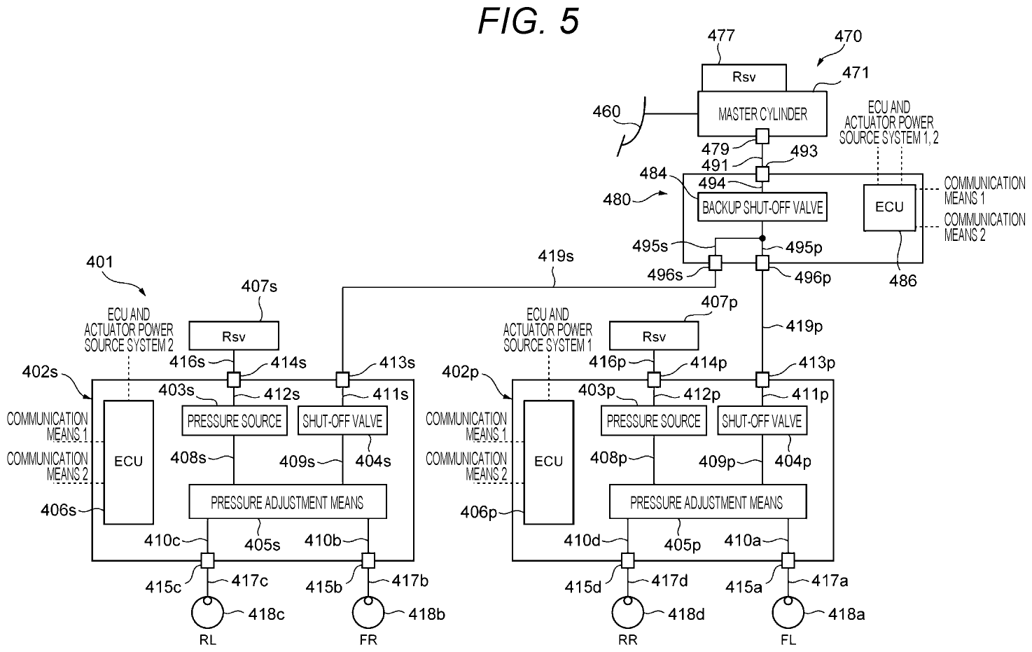

FIG. 5 is a configuration diagram of a fluid pressure control system 401 according to a fourth embodiment. Unlike the first to third embodiments, the fluid pressure control system 401 is a system assumed to be applied to automatic driving vehicles of Level 3 or higher, and is configured in consideration of a response to braking force application by a driver's brake pedal operation.

The fluid pressure control system 401 generates a brake fluid pressure (wheel cylinder fluid pressure) in the wheel cylinder (braking force applying unit) 418 to press a brake pad provided on each of the wheels FL to RR against a brake disc provided on the wheel side to apply a braking force to each of the wheels FL to RR.

The fluid pressure control system 401 includes a first unit 402p and a second unit 402s. Each of the first unit 402p and the second unit 402s is a unit in which a pressure source 403, a shut-off valve 404, a pressure adjustment means 405, and an ECU 406 are integrally provided.

In addition, a brake pedal 460, a master cylinder 470, and a fail-safe unit 480 are provided. The brake pedal 460 is connected to the master cylinder 470.

The first unit 402p and the second unit 402s have a unit connection port 413, a suction port 414, and a wheel cylinder port 415.

The unit connection port 413 is connected to a unit connection pipe 419 and is connected to the shut-off valve 404 via a connection fluid path 411. The first unit 402p and the second unit 402s are connected via unit connection pipes 419p/419s and connection fluid paths 495p/495s in the fail-safe unit 480.

The suction port 414 is connected to a suction hose 416 and is connected to the pressure source 403 via the connection fluid path 412. The first unit 402p and the second unit 402s are connected to a reservoir tank 407 via the suction hose 416. The reservoir tank 407 is a brake fluid source which stores brake fluid, and is a low pressure portion in which the atmospheric pressure is released.

The wheel cylinder port 415 is connected to a wheel cylinder pipe 417 and is connected to the pressure adjustment means 405 via a connection fluid path 410. The first unit 402p and the second unit 402s are connected to the wheel cylinder 418 via the wheel cylinder pipe 417. A so-called X (cross) piping configuration where the primary system of the first unit 402p is connected to a left front wheel cylinder 418a and a right rear wheel cylinder 418d, while the secondary system of the second unit 402s is connected to a right front wheel cylinder 418b and a left rear wheel cylinder 418c, is adopted. An H pipe connecting the front wheel to the primary system and the rear wheel to the secondary system may be used.

The pressure source 403 and the pressure adjustment means 405 are connected via a connection fluid path 408. In addition, the shut-off valve 404 and the pressure adjustment means 405 are connected via a connection fluid path 409.

The brake pedal 460 receives driver's pedal force and transmits the force to the master cylinder 470.

The master cylinder 470 includes a master cylinder body 471, a reservoir tank 477, and an output port 479. The master cylinder body 471 converts the force transmitted from the brake pedal 460 into pressure. The reservoir tank 477 is a brake fluid source that stores brake fluid to be supplied to the master cylinder body 471, and is a low pressure portion in which atmospheric pressure is released. The output port 479 is connected to a master cylinder pipe 491.

The fail-safe unit 480 includes a backup shut-off valve 484, an ECU 486, a master cylinder port 493, and a unit connection port 496. The master cylinder port 493 is connected to the master cylinder pipe 491 and is connected to the backup shut-off valve 484 via the connection fluid path 494. The master cylinder 470 and the fail-safe unit 480 are connected via the master cylinder pipe 491. The unit connection port 496 is connected to the unit connection pipe 419 and is connected to the backup shut-off valve 484 via the connection fluid path 495. As illustrated in FIG. 5, unit connection ports 496p/496s are connected to the connection fluid path 495p/495s in the fail-safe unit 480.

The pressure source 403 sucks the brake fluid stored in the reservoir tank 407 and discharges fluid of a required flow rate to the pressure adjustment means 405 based on a command from the ECU 406.

The pressure adjustment means 405 adjusts the pressure of the brake fluid supplied from the pressure source 403 based on a command from the ECU 406, and outputs a desired pressure to the wheel cylinder 418 and the shut-off valve 404 side. Here, in the pressure adjustment means 405, the connection fluid path 409 and the connection fluid path 410 communicate with each other (not illustrated).

The shut-off valve 404 opens or closes based on a command from the ECU 406 to communicate or block between the connection fluid path 409 and the connection fluid path 411. Note that the shut-off valve 404 has a so-called normally open structure, and the shut-off valve 404 is opened, that is, the connection fluid path 409 and the connection fluid path 411 are in an open state, or a communicating state when there is no command (electric signal) from the ECU 406 or no electricity is supplied.

The ECU 406 is an electronic control unit (ECU) that controls the first unit 402p and the second unit 402s, receives a signal (target brake fluid pressure) from another ECU, and controls the pressure source 403, the shut-off valve 404, and the pressure adjustment means 405 as described above. In the present embodiment, the operation amount of the brake pedal 460 by the driver may be detected, for example, by a pedal stroke sensor (not illustrated) or the like, and the target brake fluid pressure may be set based on the operation amount.

The backup shut-off valve 484 in the fail-safe unit 480 opens or closes based on a command from the ECU 486 to communicate or block between the connection fluid path 494 and the connection fluid path 495. Note that the backup shut-off valve 484 has a so-called normally open structure, and the backup shut-off valve 484 is opened, that is, the connection fluid path 494 and the connection fluid path 495 are in an open state, or a communicating state when there is no command (electric signal) from the ECU 486 or no electricity is supplied.

The ECU 486 is an electronic control unit (ECU), receives a signal from other ECUs, and controls the backup shut-off valve 484. The ECU 486 of the present embodiment corresponds to the third control unit in the claims, and the backup shut-off valve 484 of the present embodiment corresponds to the third shut-off valve in the claims.

Next, the operation of the fluid pressure control system 401 according to the fourth embodiment will be described.

(Normal Control in System Normal State)

In the first unit 402p and the second unit 402s, the shut-off valve 404 is closed by a command from the ECU 406, and the connection fluid path 409 and the connection fluid path 411 are blocked. In addition, the pressure source 403 and the pressure adjustment means 405 are controlled, and a desired pressure is output to the wheel cylinder 418.

In addition, in the fail-safe unit 480, the backup shut-off valve 484 is opened according to a command from the ECU 486.

In this state, since the shut-off valve 404 is closed in the first unit 402p and the second unit 402s, even when the backup shut-off valve 484 is opened, the pressure adjusted by the pressure adjustment means 405 does not flow out to the master cylinder 470 (reservoir tank 477) side, a desired pressure can be output to the wheel cylinder 418, and a necessary braking force can be applied to each of the wheels FL to RR of the wheel cylinder 418.

(Backup Control at the Time of System Failure)

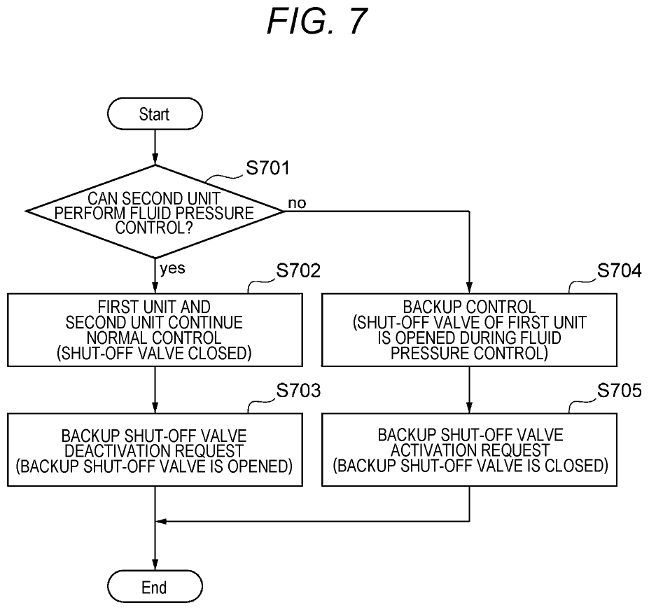

Here, as an example, processing performed by the ECU 406/ECU 486 when the second unit 402s fails will be described according to the flowchart of FIG. 7.

In step S701, it is determined whether the second unit 402s can perform fluid pressure control. The determination is made by a failure detection logic (not illustrated) of the pressure source 403, the shut-off valve 404, the pressure adjustment means 405, and the ECU 406 incorporated in the ECU 406. When it is determined that the fluid pressure control is possible, the process proceeds to step S702. When it is determined that the fluid pressure control is impossible, or the system fails, the process proceeds to step S704.

In step S702, the first unit 402p and the second unit 402s continue the normal control at the system normal state described in the paragraph [0100], and the process proceeds to step S703.

In step S703, as described in the paragraph [0100] above, the fail-safe unit 480 opens the backup shut-off valve 484. In this case, as described above, a desired pressure can be output to the wheel cylinder 418, and a necessary braking force can be applied to each of the wheels FL to RR of the wheel cylinder 418.

In step S704, the process proceeds to backup control. That is, the shut-off valve 404p of the first unit 402p is opened. With this operation, a connection fluid path 409p and a connection fluid path 411p communicate with each other, and the pressure adjusted by the pressure adjustment means 405p is applied to a unit connection port 496p of the fail-safe unit 480 via the unit connection pipe 419p together with the wheel cylinders 418a/418d.

In step S705, the fail-safe unit 480 closes the backup shut-off valve 484. As a result, the pressure adjusted by the pressure adjustment means 405p is prevented from flowing out to the master cylinder 470 (reservoir tank 477) side, and the pressure is applied from the unit connection port 496p of the fail-safe unit 480 to a unit connection port 413s of the second unit 402s via connection fluid paths 495p/495s, a unit connection port 496s, and a unit connection pipe 419s.

In the second unit 402s, when it is determined that the system fails, the pressure source 403s, the shut-off valve 404s, and the pressure adjustment means 405s are deactivated (non-electrified), the shut-off valve 404s is opened, and a connection fluid path 409s and a connection fluid path 411s communicate with each other.

Therefore, the pressure adjusted by the pressure adjustment means 405p of the first unit 402p is also applied to wheel cylinders 418b/418c from a unit connection port 413s of the second unit 402s via the connection fluid path 411s, the connection fluid path 409s, the pressure adjustment means 405s, connection fluid paths 410b/410c, wheel cylinder ports 415b/415c, and wheel cylinder pipes 417b/417c.

As a result, even when the second unit 402s fails, a desired pressure is output to the wheel cylinder 418 similarly to the system normal state, and a necessary braking force can be applied to each of the wheels FL to RR of the wheel cylinder 418.

Note that the above is an example of a case where the second unit 402s fails, but even in a case where the first unit 402p fails, the first unit 402p and the second unit 402s are only replaced in the processing of step S704, and the operation itself is similar.

(Depression Brake at the Time of Total System Failure)

In the fluid pressure control system 401, for example, when all of the first unit 402p, the second unit 402s, and the fail-safe unit 480 fail due to all power supply failures or the like, the braking force is secured by the driver's brake pedal operation by the following method.

The driver's pedal force applied to the brake pedal 460 is transmitted to the master cylinder body 471 and converted into pressure. The pressure is applied from the output port 479 to the master cylinder port 493 of the fail-safe unit 480 via the master cylinder pipe 491.

Note that the backup shut-off valve 484 has a so-called normally open structure, and the backup shut-off valve 484 is opened, that is, the connection fluid path 494 and the connection fluid path 495 are in an open state, or a communicating state in the failure state, that is, when there is no command (electric signal) from the ECU 486 or no electricity is supplied. Therefore, the pressure applied to the master cylinder port 493 is applied from the unit connection port 496 to the unit connection port 413 of the first unit 402p and the second unit 402s via the unit connection pipe 419. When the first unit 402p and the second unit 402s are in the failure state, the pressure source 403, the shut-off valve 404, and the pressure adjustment means 405 are deactivated (non-electrified), the shut-off valve 404 is opened, and the connection fluid path 409 and the connection fluid path 411 communicate with each other as described above. That is, the ECU 486 opens the backup shut-off valve 484 when failure of both the first unit 402p and the second unit 402s is detected.

Therefore, the pressure generated in the master cylinder 470 by the driver's pedal force is applied to the wheel cylinder 418 from the unit connection port 413 via the connection fluid path 411, the connection fluid path 409, the pressure adjustment means 405, the connection fluid path 410, the wheel cylinder port 415, and the wheel cylinder pipe 417, and a necessary braking force can be applied to each of the wheels FL to RR of the wheel cylinder 418.

Next, operational effects of the fourth embodiment will be described.

The fluid pressure control system 401 according to the fourth embodiment includes the brake pedal 460, the master cylinder 470, the fail-safe unit 480, and two units having the same configuration, the first unit 402p and the second unit 402s. The first unit 402p has the ECU 406p, and the second unit 402s has the ECU 106s. In each unit, the shut-off valve 404 controlled only by the ECU 406 included in each unit is provided. The upstream side (the side opposite to the wheel cylinder) of the shut-off valve 404 provided in each unit is connected by the unit connection pipe 419, and the backup shut-off valve 484 controlled by the ECU 486 is provided between the unit connection pipe 419 and the master cylinder 470.

Therefore, since these units and the ECUs included in each unit are separated, even if a failure occurs in one of the first unit 402p and the second unit 402s or the ECU of one of the first unit 402p and the second unit 402s, the other unit or ECU is not affected by the failure. Also, by closing the backup shut-off valve 484, the pressure is prevented from flowing out to the master cylinder 470 (reservoir tank 477) side, the discharge fluid pressure from the other unit can be supplied to all the wheels, and the braking force can be secured, so that higher reliability can be obtained.

In addition, since each of the two units, the first unit 402p and the second unit 402s has the same configuration, and does not have a configuration in which the shut-off valve is controlled by the two ECUs as shown in the prior art, there is also an advantage that the system configuration is simplified.

Furthermore, in this configuration, even when all of the first unit 402p, the second unit 402s, and the fail-safe unit 480 fail due to all power supply failures or the like, the pressure generated in the master cylinder 470 by the driver's pedal force is applied to the wheel cylinder 418, and a necessary braking force can be applied to each of the wheels FL to RR of the wheel cylinder 418, so that higher reliability can be secured.

### Fifth Embodiment

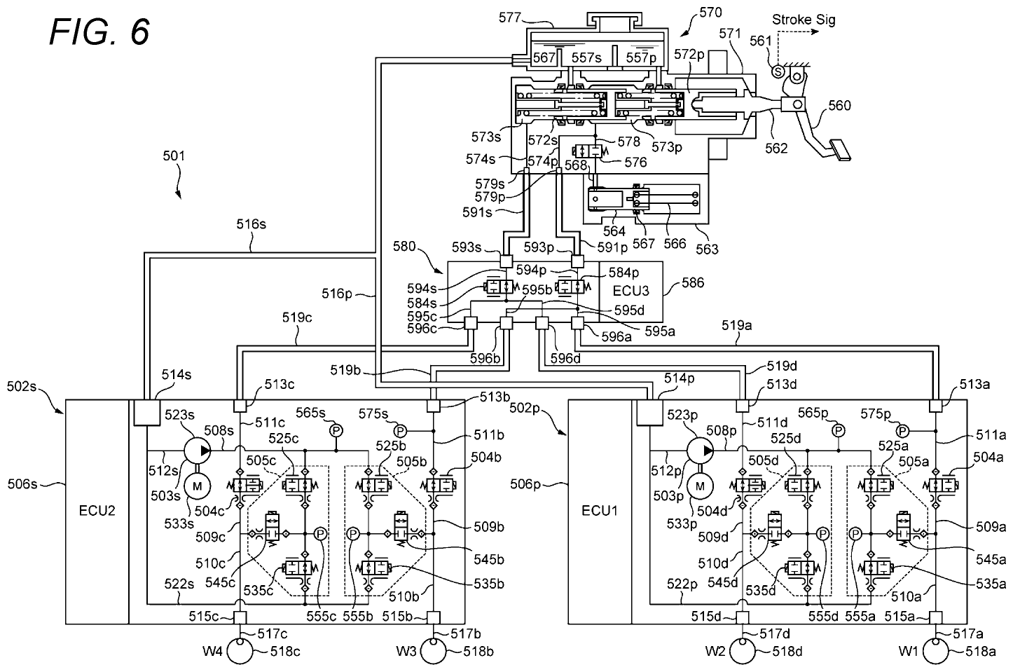

FIG. 6 is a configuration diagram of a fluid pressure control system 501 according to a fifth embodiment. Unlike the first to third embodiments, the fluid pressure control system 501 is a system assumed to be applied to automatic driving vehicles of Level 3 or higher, and is configured in consideration of a response to braking force application by a driver's brake pedal operation.

The fluid pressure control system 501 generates a brake fluid pressure (wheel cylinder fluid pressure) in the wheel cylinder (braking force applying unit) 518 to press a brake pad provided on each of the wheels FL to RR against a brake disc provided on the wheel side to apply a braking force to each of the wheels FL to RR.

The fluid pressure control system 501 includes a first unit 502p and a second unit 502s. Each of the first unit 502p and the second unit 502s is a unit in which a pressure source 503, a shut-off valve 504, a pressure adjustment means 505, and an ECU 506 are integrally provided.

In addition, a brake pedal 560, a master cylinder 570, and a fail-safe unit 580 are provided.

The first unit 502p and the second unit 502s have a unit connection port 513, a suction port 514, and a wheel cylinder port 515.

The unit connection port 513 is connected to a unit connection pipe 519 and is connected to the shut-off valve 504 via a connection fluid path 511. The first unit 502p and the second unit 502s are connected via unit connection pipes 519a/519b, unit connection pipes 519c/519d, connection fluid paths 595a/595b in the fail-safe unit 580, and connection fluid paths 595c/595d.

The suction port 514 is connected to a suction hose 516 and is connected to the pressure source 503 via the connection fluid path 512. The first unit 502p and the second unit 502s are connected to a fluid chamber 567 of a reservoir tank 577 via the suction hose 516. The reservoir tank 577 is a brake fluid source which stores brake fluid, and is a low pressure portion in which the atmospheric pressure is released. The reservoir tank 577 is divided into three fluid chambers 557p/557s/567, and the fluid chambers 557p/557s are connected to a master cylinder 570 described later.

The wheel cylinder port 515 is connected to a wheel cylinder pipe 517 and is connected to the pressure adjustment means 505 via a connection fluid path 510. The first unit 502p and the second unit 502s are connected to the wheel cylinder 518 via the wheel cylinder pipe 517. A so-called X (cross) piping configuration where the primary system of the first unit 502p is connected to a left front wheel cylinder 518a and a right rear wheel cylinder 518d, while the secondary system of the second unit 502s is connected to a right front wheel cylinder 518b and a left rear wheel cylinder 518c, is adopted. An H pipe connecting the front wheel to the primary system and the rear wheel to the secondary system may be used.

The pressure source 503 and the pressure adjustment means 505 are connected via a connection fluid path 508. In addition, the shut-off valve 504 and the pressure adjustment means 505 are connected via a connection fluid path 509.

The brake pedal 560 receives driver's pedal force and transmits the force to the master cylinder 570 via a push rod 562.

The master cylinder 570 includes a master cylinder body 571, a reservoir tank 577, and an output port 579. The master cylinder body 571 includes a piston 572 therein, converts force transmitted from the brake pedal 560 into pressure, and outputs the pressure from a pressure chamber 573 to the output port 579 via a connection fluid path 574. The reservoir tank 577 is a brake fluid source that stores the brake fluid to be supplied to the master cylinder body 571, is a low pressure portion in which the atmospheric pressure is released, has the fluid chambers 557p/557s as described above, and supplies the brake fluid to each of pressure chambers 573p/573s. The output port 579 is connected to a master cylinder pipe 591.

The master cylinder 570 is integrally provided with a stroke simulator 563. The stroke simulator 563 operates in accordance with a brake operation by the driver and generates a brake pedal feeling (stepping feeling). By the brake pedal operation by the driver, a primary piston 572p of the master cylinder 570 moves, the brake fluid pushed out thereby flows into the stroke simulator 563 via a connection fluid path 578 and an input port 568, and a simulator piston 564 is displaced, thereby generating a pedal stroke. In addition, a spring 566 is provided in contact with an end surface of the simulator piston 564 on a side to which the brake fluid from the master cylinder 570 is not applied, a spring reaction force according to the displacement of the simulator piston 564 is transmitted to the simulator piston 564, and a pressure generated by the reaction force is transmitted to the primary piston 572p of the master cylinder 570 to generate a pedal reaction force.

The connection fluid path 578 is provided with a stroke simulator cut valve 576 controlled by an ECU 586 in a fail-safe unit 580.

The fail-safe unit 580 includes a backup shut-off valve 584, the ECU 586, a master cylinder port 593, and a unit connection port 596. The master cylinder port 593 is connected to the master cylinder pipe 591 and is connected to the backup shut-off valve 584 via the connection fluid path 594. The master cylinder 570 and the fail-safe unit 580 are connected via the master cylinder pipe 591. The unit connection port 596 is connected to the unit connection pipe 519 and is connected to the backup shut-off valve 584 via the connection fluid path 595. As illustrated in FIG. 6, the unit connection ports 596a/596b are connected via the connection fluid paths 595a/595b in the fail-safe unit 580, and unit connection ports 596c/596d are connected via the connection fluid paths 595c/595d in the fail-safe unit 580.

The pressure source 503 includes a pump 523 and a motor 533 that drives the pump. Based on a command from the ECU 506, the motor 533 is rotationally controlled to suck the brake fluid stored in the reservoir tank 577 and discharge fluid of a required flow rate to the pressure adjustment means 505.

The pressure adjustment means 505 includes a pressure increasing control valve 525, a pressure reducing control valve 535, a communication valve 545, a pressure sensor 555, and a pressure sensor 565, and adjusts the pressure of the brake fluid supplied from the pressure source 503 based on a command from the ECU 506. That is, the pressure detected by the pressure sensors 555/565 is fed back. When the pressure is increased, the pressure increasing control valve 525 is opened, and the pressure reducing control valve 535 is closed. When the pressure is reduced, the pressure increasing control valve 525 is closed, and the pressure reducing control valve 535 is opened. As a result, a desired pressure is obtained. The adjusted pressure is output to the wheel cylinder 518 and the shut-off valve 504 side by opening the communication valve 545.

The shut-off valve 504 opens or closes based on a command from the ECU 506 to communicate or block between the connection fluid path 509 and the connection fluid path 511. Note that the shut-off valve 504 has a so-called normally open structure, and the shut-off valve 504 is opened, that is, the connection fluid path 509 and the connection fluid path 511 are in an open state, or a communicating state when there is no command (electric signal) from the ECU 506 or no electricity is supplied.

The ECU 506 is an electronic control unit (ECU) that controls the first unit 502p and the second unit 502s, receives a signal (target brake fluid pressure) from another ECU, and controls the pressure source 503, the shut-off valve 504, and the pressure adjustment means 505 as described above. In the present embodiment, the operation amount of the brake pedal 560 by the driver may be detected, for example, by a pedal stroke sensor 561 or the like, and the target brake fluid pressure may be set based on the operation amount.

The stroke simulator cut valve 576 provided in the master cylinder 570 opens or closes based on a command from the ECU 586 in the fail-safe unit 580, and communicates or blocks the connection fluid path 578, that is, communicates or blocks the master cylinder 570 and the stroke simulator 563. Note that the stroke simulator cut valve 576 has a so-called normally close structure, and the stroke simulator cut valve 576 is closed, that is, the master cylinder 570 and the stroke simulator 563 are in a close state, or a blocking state when there is no command (electric signal) from the ECU 586 or no electricity is supplied.

The backup shut-off valve 584 in the fail-safe unit 580 opens or closes based on a command from the ECU 586 to communicate or block between the connection fluid path 594 and the connection fluid path 595. Note that the backup shut-off valve 584 has a so-called normally open structure, and the backup shut-off valve 584 is opened, that is, the connection fluid path 594 and the connection fluid path 595 are in an open state, or a communicating state when there is no command (electric signal) from the ECU 586 or no electricity is supplied.

The ECU 586 is an electronic control unit (ECU), receives a signal from other ECUs, and controls the backup shut-off valve 584 and the stroke simulator cut valve 576 described above.

Next, the operation of the fluid pressure control system 501 according to the fifth embodiment will be described.

(Normal control in system normal state) In the first unit 502p and the second unit 502s, the shut-off valve 504 is closed based on a command from the ECU 506, and the connection fluid path 509 and the connection fluid path 511 are blocked. In addition, the pressure source 503 and the pressure adjustment means 505 are controlled, and a desired pressure is output to the wheel cylinder 518.

In the master cylinder 570, the stroke simulator cut valve 576 is opened based on a command from the ECU 586.

Furthermore, in the fail-safe unit 580, the backup shut-off valve 584 is opened based on a command from the ECU 586.

In this state, since the shut-off valve 504 is closed in the first unit 502p and the second unit 502s, even when the backup shut-off valve 584 is opened, the pressure adjusted by the pressure adjustment means 505 does not flow out to the master cylinder 570 (reservoir tank 577) side, a desired pressure can be output to the wheel cylinder 518, and a necessary braking force can be applied to each of the wheels FL to RR of the wheel cylinder 518.

In addition, the master cylinder 570 and the stroke simulator 563 communicate with each other, so that brake pedal feeling (stepping feeling) according to the brake operation of the driver is generated.

(Backup Control at the Time of System Failure)

Here, as an example, processing performed by the ECU 506/ECU 586 when the second unit 502s fails will be described according to the flowchart of FIG. 7.

In step S701, it is determined whether the second unit 502s can perform fluid pressure control. The determination is made by a failure detection logic (not illustrated) of the pressure source 503, the shut-off valve 504, the pressure adjustment means 505, and the ECU 506 incorporated in the ECU 506. When it is determined that the fluid pressure control is possible, the process proceeds to step S702. When it is determined that the fluid pressure control is impossible, or the system fails, the process proceeds to step S704.

In step S702, the first unit 502p and the second unit 502s continue the normal control at the system normal state described in the paragraph [0143], and the process proceeds to step S703.

In step S703, as described in the paragraph [0143] above, the fail-safe unit 580 opens the backup shut-off valve 584. In this case, as described above, a desired pressure can be output to the wheel cylinder 518, and a necessary braking force can be applied to each of the wheels FL to RR of the wheel cylinder 518.

In step S704, the process proceeds to backup control. That is, a shut-off valves 504a/504d of the first unit 502p is opened. With this operation, a connection fluid path 509a and a connection fluid path 511a, and a connection fluid path 509d and a connection fluid path 511d communicate with each other, and the pressure adjusted by the pressure adjustment means 505a/505d is applied to unit connection ports 596a/596d of the fail-safe unit 580 via the unit connection pipes 519a/519d together with the wheel cylinders 518a/518d.

In the master cylinder 570, the stroke simulator cut valve 576 is opened.

In step S705, the fail-safe unit 580 closes the backup shut-off valve 584p/584s. As a result, the pressure adjusted by the pressure adjustment means 505a/505d is prevented from flowing out to the master cylinder 570 (reservoir tank 577) side, and the pressure is applied from the unit connection ports 596a/596d of the fail-safe unit 580 to unit connection ports 513b/513c of the second unit 502s via connection fluid paths 595a/595b, connection fluid paths 595c/595d, unit connection ports 596b/596c, and unit connection pipes 519b/519c.

In the second unit 502s, when it is determined that the system fails, the pressure source 503s, the shut-off valves 504b/504c, and the pressure adjustment means 505b/505c are deactivated (non-electrified), the shut-off valves 504b/504c is opened, and a connection fluid path 509b and a connection fluid path 511b, and a connection fluid path 509c and a connection fluid path 511c communicate with each other.

Therefore, the pressure adjusted by the pressure adjustment means 505a/505d of the first unit 502p is also applied to wheel cylinders 518b/518c from unit connection ports 513b/513c of the second unit 502s via connection fluid paths 511b/511c, connection fluid paths 509b/509c, connection fluid paths 510b/510c, wheel cylinder ports 515b/515c, and wheel cylinder pipes 517b/517c.

As a result, even when the second unit 502s fails, a desired pressure is output to the wheel cylinder 518 similarly to the system normal state, and a necessary braking force can be applied to each of the wheels FL to RR of the wheel cylinder 518.

In addition, the master cylinder 570 and the stroke simulator 563 communicate with each other, so that brake pedal feeling (stepping feeling) according to the brake operation of the driver is generated, similarly to the system normal state.

Note that the above is an example of a case where the second unit 502s fails, but even in a case where the first unit 1502p fails, the first unit 502p and the second unit 502s are only replaced in the processing of step S704, and the operation itself is similar.

(Depression Brake at the Time of Total System Failure)

In the fluid pressure control system 501, for example, when all of the first unit 502p, the second unit 502s, the fail-safe unit 580, and the stroke simulator cut valve 576 provided in the master cylinder 570 fail due to all power supply failures or the like, the braking force is secured by the driver's brake pedal operation by the following method.

The driver's pedal force applied to the brake pedal 560 is transmitted to the master cylinder body 571 via the push rod 562 and converted into pressure. The pressure is applied from the output port 579 to the master cylinder port 593 of the fail-safe unit 480 via the master cylinder pipe 591.

The stroke simulator cut valve 576 has a so-called normally close structure, and the stroke simulator cut valve 576 is closed, that is, the master cylinder 570 and the stroke simulator 563 are in a close state or a blocking state when there is no command (electric signal) from the ECU 586 or no electricity is supplied. Therefore, it is possible to prevent the brake fluid pushed out from the primary piston 572p of the master cylinder 570 by the driver's brake pedal operation from flowing into the stroke simulator 563, that is, the brake fluid amount supplied to the wheel cylinder 518 described later is prevented from decreasing.

The backup shut-off valve 584 has a so-called normally open structure, and the backup shut-off valve 584 is opened, that is, the connection fluid path 594 and the connection fluid path 595 are in an open state, or a communicating state in the failure state, that is, when there is no command (electric signal) from the ECU 586 or no electricity is supplied. Therefore, the pressure applied to the master cylinder port 593 is applied from the unit connection port 596 to the unit connection port 513 of the first unit 502p and the second unit 502s via the unit connection pipe 519. When the first unit 502p and the second unit 502s are in the failure state, the pressure source 503, the shut-off valve 504, and the pressure adjustment means 505 are deactivated (non-electrified), the shut-off valve 504 is opened, and the connection fluid path 509 and the connection fluid path 511 communicate with each other as described above.

Therefore, the pressure generated in the master cylinder 570 by the driver's pedal force is applied to the wheel cylinder 518 from the unit connection port 513 via the connection fluid path 511, the connection fluid path 509, the connection fluid path 510, the wheel cylinder port 515, and the wheel cylinder pipe 517, and a necessary braking force can be applied to each of the wheels FL to RR of the wheel cylinder 518.

Next, operational effects of the fifth embodiment will be described.

The fluid pressure control system 501 according to the fifth embodiment includes the brake pedal 560, the master cylinder 570, the fail-safe unit 580, the stroke simulator 563, and two units having the same configuration, the first unit 502p and the second unit 502s. The first unit 502p has an ECU 506p, and the second unit 502s has the ECU 506s. In each unit, the shut-off valve 504 controlled only by the ECU 506 included in each unit is provided. The upstream side (the side opposite to the wheel cylinder) of the shut-off valve 504 provided in each unit is connected by the unit connection pipe 519, and the backup shut-off valve 584 controlled by the ECU 486 is provided between the unit connection pipe 519 and the master cylinder 570.

Therefore, since these units and the ECUs included in each unit are separated, even if a failure occurs in one of the first unit 502p and the second unit 502s or the ECU of one of the first unit 502p and the second unit 502s, the other unit or ECU is not affected by the failure. Also, by closing the backup shut-off valve 584, the pressure is prevented from flowing out to the master cylinder 570 (reservoir tank 577) side, the discharge fluid pressure from the other unit can be supplied to all the wheels, and the braking force can be secured, so that higher reliability can be obtained.

In addition, the stroke simulator 563 can generate brake pedal feeling (stepping feeling) according to the brake operation of the driver even at the time of failure, similarly to the system normal state.

In addition, since each of the two units, the first unit 502p and the second unit 502s has the same configuration, and does not have a configuration in which the shut-off valve is controlled by the two ECUs as shown in the prior art, there is also an advantage that the system configuration is simplified.

Furthermore, in this configuration, even when all of the first unit 502p, the second unit 502s, the fail-safe unit 580, and the stroke simulator cut valve 576 provided in the master cylinder 570 fail due to all power supply failures or the like, the pressure generated in the master cylinder 570 by the driver's pedal force is applied to the wheel cylinder 518, and a necessary braking force can be applied to each of the wheels FL to RR of the wheel cylinder 518, so that higher reliability can be secured.

### OTHER EMBODIMENTS

Although the embodiments for carrying out the present invention have been described above, the specific configuration of the present invention is not limited to the configuration of the embodiments, and design changes and the like without departing from the gist of the invention are included in the present invention.

For example, in the embodiments, the pressure source includes a pump and a motor that drives the pump, but the pump may be any of a plunger pump, a rotary pump, and the like, or may be an electric piston operated by an electric motor.

Although the embodiments of the present invention have been described in detail above, the present invention is not limited to the above embodiments, and various design changes can be made without departing from the spirit of the present invention described in the claims. For example, the above-described embodiments have been described in detail in order to simply describe the present invention, and are not necessarily limited to those having all the described configurations. In addition, a part of the configuration of a certain embodiment can be replaced with the configuration of another embodiment, and the configuration of another embodiment can be added to the configuration of a certain embodiment. In addition, it is also possible to add, delete, or replace other configurations for a part of the configuration of each embodiment.

### REFERENCE SIGNS LIST

101 fluid pressure control system (brake device)
102p first unit (first fluid pressure unit)
102s second unit (second fluid pressure unit)
103p pressure source (first pressure feeding unit)
103s pressure source (second pressure feeding unit)
104p shut-off valve (first shut-off valve)
104s shut-off valve (second shut-off valve)
105p pressure adjustment means (first pressure adjustment unit)
105s pressure adjustment means (second pressure adjustment unit)
106p ECU (first control unit)
106s ECU (second control unit)
107 reservoir tank
118a, 118d wheel cylinder (first wheel cylinder)
118b, 118c wheel cylinder (second wheel cylinder)
119 Unit connection pipe (connection pipe)
460 brake pedal
470 master cylinder
480 fail-safe unit
484 backup shut-off valve (third shut-off valve)
486 ECU (third control unit)
491 master cylinder pipe

1. A brake device mounted on a vehicle, the brake device comprising:
a first fluid pressure unit which supplies brake fluid to at least one first wheel cylinder;
a second fluid pressure unit which supplies brake fluid to at least one second wheel cylinder; and
a connection pipe which connects the first fluid pressure unit and the second fluid pressure unit to allow the brake fluid to flow therethrough;
wherein
the first fluid pressure unit includes a first shut-off valve which blocks flow of the brake fluid relative to the connection pipe, and a first control unit which controls opening and closing of the first shut-off valve,
the second fluid pressure unit includes a second shut-off valve which blocks flow of the brake fluid relative to the connection pipe, and a second control unit which controls opening and closing of the second shut-off valve, and
the first control unit and the second control unit respectively open the first shut-off valve and the second shut-off valve in a case where a failure of at least one of the first fluid pressure unit and the second fluid pressure unit is detected.

2. The brake device according to claim 1, wherein the first fluid pressure unit and the second fluid pressure unit have a same configuration.

3. The brake device according to claim 1, wherein
the first shut-off valve and the second shut-off valve are electromagnetic valves which are blocked by electrification, and
the first control unit and the second control unit stop electrification to the first shut-off valve by the first control unit and stop electrification to the second shut-off valve by the second control unit in a case where a failure of either the first fluid pressure unit or the second fluid pressure unit is detected.

4. The brake device according to claim 1, wherein
the first fluid pressure unit includes a first pressure feeding unit which pressure-feeds the brake fluid, and a first pressure adjustment unit which adjusts a fluid pressure of the brake fluid, and
the first pressure adjustment unit is connected to the first shut-off valve, and communicates with the connection pipe by opening the first shut-off valve.

5. The brake device according to claim 1, wherein
the second fluid pressure unit includes a second pressure feeding unit which pressure-feeds the brake fluid, and a second pressure adjustment unit which adjusts a fluid pressure of the brake fluid, and
the second pressure adjustment unit is connected to the second shut-off valve, and communicates with the connection pipe by opening the second shut-off valve.

6. The brake device according to claim 1, comprising:
a master cylinder coupled to a brake pedal;
a master cylinder pipe one end of which is connected to the master cylinder and an other end of which is connected to the connection pipe;
a third shut-off valve disposed in a middle of the master cylinder pipe; and
a third control unit which controls opening and closing of the third shut-off valve,
wherein the third control unit:
opens the third shut-off valve in a case where both the first fluid pressure unit and the second fluid pressure unit are normal;
blocks the third shut-off valve in a case where a failure of either of the first fluid pressure unit and the second fluid pressure unit is detected; and
opens the third shut-off valve in a case where a failure of both the first fluid pressure unit and the second fluid pressure unit is detected.

7. The brake device according to claim 6, wherein
the third shut-off valve is an electromagnetic valve which is closed by electrification and opened by non-electrification, and
electrification to the third shut-off valve is stopped in a case where both the first fluid pressure unit and the second fluid pressure unit are normal, or a failure is detected in both the first fluid pressure unit and the second fluid pressure unit.
